(19) United States
(12) Patent Application Publication
(10) Pub. No.: US 2009/0313540 A1
(43) Pub. Date: Dec. 17, 2009

(54) Methods and systems for automated text evaluation

(76) Inventor: Mark Otuteye, North Tustin, CA (US)

Correspondence Address: CHRISTINE JOHNSON ESQ., 151 Trenton Rd., Fairless Hills, PA, 19030, US

(21) Appl. No.: 12/139,468

(22) Filed: Jun. 14, 2008

(51) Int. Cl. G06F 17/21

(52) U.S. Cl. 715/272

(57) ABSTRACT

Embodiments of the invention provide systems and methods for evaluating text. A system of an embodiment of the invention includes including an input for receiving text to be evaluated and an output for providing an evaluation outcome. A feature module is coupled to the input to receive the text. The feature module provides a feature count for at least one feature of the text. A rule module comprises at least one text evaluation rule. An evaluation module is coupled to the feature module and to the rule module. The evaluation module applies the evaluation rule to the feature count to provide an evaluation outcome.

### FIELD OF THE INVENTION

The present invention relates generally to methods and systems for automatic evaluation of text and in particular to user adaptable methods and systems for evaluation of text.

### BACKGROUND OF THE INVENTION

Textual information proliferates in today's society. Electronic documents are replacing paper as the medium of choice for delivery of news, instruction and advertising. Information comprising text in electronic form is stored in electronic archives and databases throughout the world. Electronic archives store diverse information, for example, scholarly works, research papers, patents, and the text of international treaties to name but a few. These are published in electronic form and accessible, for example, via the Internet.

The sheer volume of electronic documents existing on databases throughout the world presents a challenge to the human “consumer” of text. The task of identifying electronic documents having textual information that is valuable and relevant to a researched subject is daunting. The task is made easier by the use of search engines. Typical search engines allow a searcher to provide key words. If the key words appear in a document the document is cited to the searcher. However, it is left to the human reader to determine the significance of the words in the context of a particular research topic.

Computer programs for evaluating meaning in electronic text are known. However, such programs are typically complex. A skilled programmer is required if changes to the evaluation approach taken by a particular computer program are desired. It would be desirable to have a text evaluation system and method that is readily adapted by a user to a variety of text evaluation applications.

Delivery of this information for instructional purposes via the internet is advancing education in many places where access to quality instructional materials had been impractical or impossible. Increasing numbers of students have at least some access to computers and the internet in an educational setting. Unfortunately, even as the number of students with computer access increases, the world faces an acute and growing shortage of teachers.

Nonetheless, without skilled evaluation and feedback of text produced by a student, the student's ability to use computers in the classroom serves limited educational purposes.

Without teachers to evaluate students' texts a goal of increasing literacy among children and adults throughout the world is difficult to achieve. While some useful automatic essay scoring systems do exist, each of the existing systems has associated drawbacks and limitations. For example, conventional systems lack mechanisms for adapting to an individual student's progress. Instead, many systems are constrained to rigid “one-size-fits-all” scoring methodologies. Further, existing systems lack means for integrating the collective experience and wisdom of students and teachers as they gain personal familiarity with a particular system, its scoring approaches and its idiosyncrasies.

Further, many existing systems and methods lack any means to provide commenting and feedback to a student writer. Those that do provide some feedback features tend to provide the feedback in forms that are not optimal for students in an educational setting. For example, one system provides feedback in the form of graphs and charts. Many existing systems are difficult even for a teacher to comprehend because underlying models are technically complex and not transparent to a user. This restricts a teacher or system administrator's ability to adjust the system to meet unique needs that may exist in a particular educational setting.

Education is but one of many environments challenged by requirements to evaluate large numbers of documents comprising text in electronic form. For example, searching medical records, researching a topic, researching specialized documents such as patent documents and a variety of other tasks require evaluation of hundreds of text documents in large databases. The texts frequently must be evaluated within a relatively short time period.

Therefore a need for web-based, remote-controllable, human-editable, embeddable, individualized, adaptable, language-independent text evaluation, scoring and commenting systems and methods exists.

### SUMMARY OF THE INVENTION

Embodiments of the invention provide systems and methods for evaluating text. A system of an embodiment of the invention includes including an input for receiving text to be evaluated and an output for providing an evaluation outcome. A feature module is coupled to the input to receive the text. The feature module provides a feature count for at least one feature of the text. A rule module comprises at least one text evaluation rule. An evaluation module is coupled to the feature module and to the rule module. The evaluation module applies the evaluation rule to the feature count to provide an evaluation outcome.

### DESCRIPTION OF THE DRAWING FIGURES

These and other objects, features and advantages of the invention will be apparent from a consideration of the following detailed description of the invention considered in conjunction with the drawing figures, in which:

FIG. 1 is a block diagram of network 10 including an automated system for evaluating text according to an embodiment of the invention;

FIG. 2 is a flowchart illustrating steps of a method for automatically evaluating text according to an embodiment of the invention;

FIG. 3 is a flowchart illustrating steps of an embodiment of the invention illustrated in FIG. 2 illustrating further steps of providing student progress reports;

FIG. 4 is a flowchart illustrating steps of an embodiment of the invention enabling user customization of evaluation features and rules;

FIG. 5 is a flowchart illustrating steps of an embodiment of the invention enabling a user to challenge an evaluation outcome;

FIG. 6 is a flowchart illustrating steps of an embodiment of the invention enabling an administrator to customize evaluation features;

FIG. 7 (deleted)

FIG. 8 is a flowchart of a scoring method according to an embodiment of the invention;

FIG. 9 is a block diagram of a challenge subsystem configured in accordance with an embodiment of the invention;

FIG. 10 is a flowchart illustrating steps of a scoring and challenge method according to an embodiment of the invention;

FIG. 11 is a block diagram illustrating a user progress subsystem according to an embodiment of the invention;

FIG. 12 is a block diagram of a commenting subsystem according to an embodiment of the invention;

FIG. 13 illustrates a graphical user interface enabling a teacher to edit a scoring model according to an embodiment of the invention;

FIG. 14 illustrates a graphical user interface enabling a student to interact with a scoring system according to an embodiment of the invention;

FIG. 15 illustrates a graphical user interface enabling a student to enter text for evaluation by a text evaluation system according to an embodiment of the invention;

FIG. 16 illustrates a display screen providing a progress report comprising scores provided by a text evaluation system according to an embodiment of the invention;

FIG. 17 illustrates a display screen enabling a teacher to select operations to be performed by a text evaluation system according to an embodiment of the invention;

FIG. 18 illustrates a display screen providing student progress information provided by a text evaluation system according to an embodiment of the invention;

FIG. 19 illustrates a graphical user interface challenging a score provided by a text evaluation system according to an embodiment of the invention;

FIG. 20 illustrates a graphical user interface enabling a teacher to edit comments provided by a text evaluation system according to an embodiment of the invention;

FIG. 21 illustrates a graphical user interface enabling a teacher to control user access to features of a text evaluation system according to an embodiment of the invention;

Appendix A provides example code for a scoring model according to an embodiment of the invention;

Appendix B provides an example Application Program Interface (API) Specification according to an embodiment of the invention;

Appendix C provides an example API code according to an embodiment of the invention.

### DETAILED DESCRIPTION OF THE INVENTION

In accordance with the present invention, there are provided herein methods and systems for automatically evaluating text.

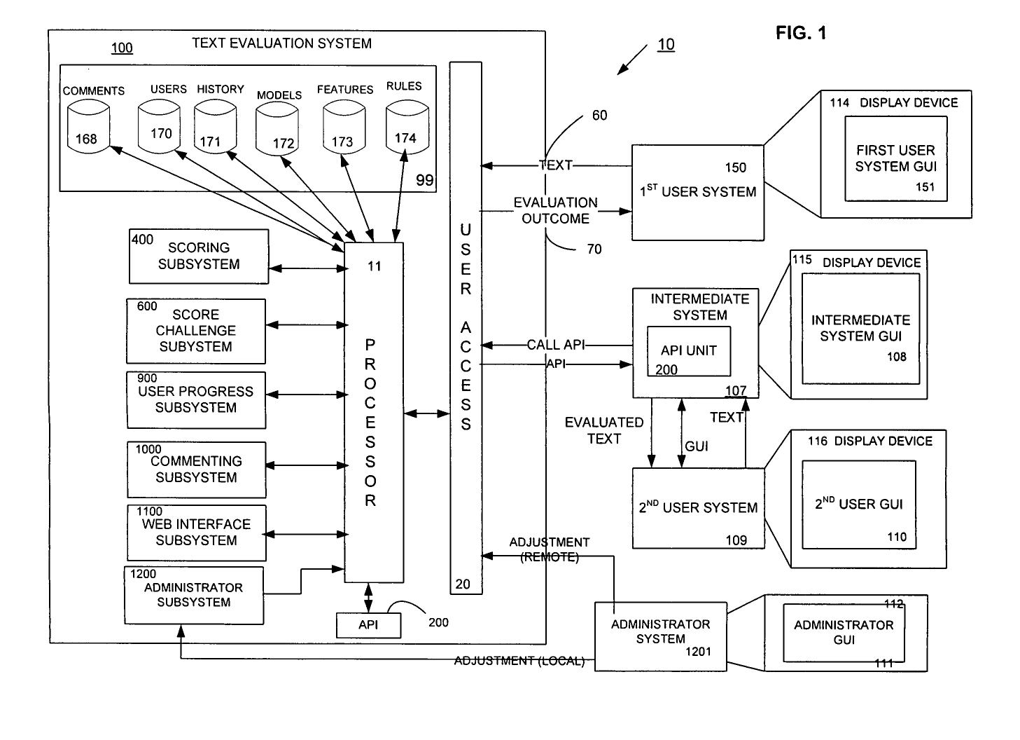

### FIG. 1 Network 10

FIG. 1 is a block diagram of an automated system 100 for evaluating text. System 100 is configurable as a standalone system according to one embodiment of the invention. According to another embodiment of the invention system 100 comprise s node of a network 10. In that embodiment system 100 is configured to communicate with other nodes of network 10 to implement various features of the invention described herein. In one example configuration network 10 is implemented at least in part as nodes communicating via the World Wide Web, or Internet. In another example configuration network 10 comprises a local area network. Both wired and wireless communication techniques are suitable for implementing embodiments of system 100 within network 10.

Regardless of network 10 implementation, automated text evaluation system 100 is configured to communicate with at least a first source of text to be evaluated. One example of a first source of text to be evaluated is a first user system 150. In some variations of the invention, a first user is a student and first user system 150 is computer system used by the student. Although only one first user system 150 is illustrated in FIG. 1, the invention is not limited with respect to a number of sources of text or first user systems communicating with system 100. Instead, embodiments of text evaluation system 100 are configurable to communicate with a virtually limitless number of sources of text including first user systems 150, for example, via a communication medium such as the World Wide Web, i.e., the Internet.

According to various embodiments of the invention network 10 further comprises at least one second source of text, for example second user system 109. An example of a second user is a teacher. In that case, second user system 109 is a computer system used by a teacher to interact with text evaluation system 100. In one embodiment of the invention second user system 109 is configured to interact with text evaluation system 100 via an intermediate system 107. In one embodiment of the invention intermediate system 107 is a third party system. Examples of third parties include educational testing services, tutoring and mentoring services and other third parties seeking to provide text evaluation services to their customers and clients.

Intermediate system 107 is configured for communication with text evaluation system 100 and second user system 109 such that text provided by second user system 109 is evaluated by intermediate system 107 in accordance with the methods described herein. In one embodiment of the invention intermediate system 107 is configured to communicate with second user system 109 and with text evaluation system 100 via the World Wide Web.

### First User System 150

A first source of text comprising, for example, first user system 150 is configured for communication with text evaluation system 100. According to some embodiments of the invention a web interface subsystem 1100 of text evaluation system 100 provides a graphical user interface (GUI) 151 for displaying interactive controls on a display device 114 of first user system 150. A user, for example a student, operates first user system 150 to interact with GUI 151 such that text to be evaluated is transmitted from first user system 150 to text evaluation system 100.

A variety of types of text are suitable for evaluation by system 100. For example, in one embodiment of the invention text to be evaluated comprises student essays. In that case an example evaluation outcome comprises an essay score. In other embodiments of the invention text to be evaluated comprises a document or collection of documents to be evaluated for document content characteristics. In that case an example evaluation outcome comprises a summary of content characteristics and an indication of the significance of the characteristics within a pre-defined context.

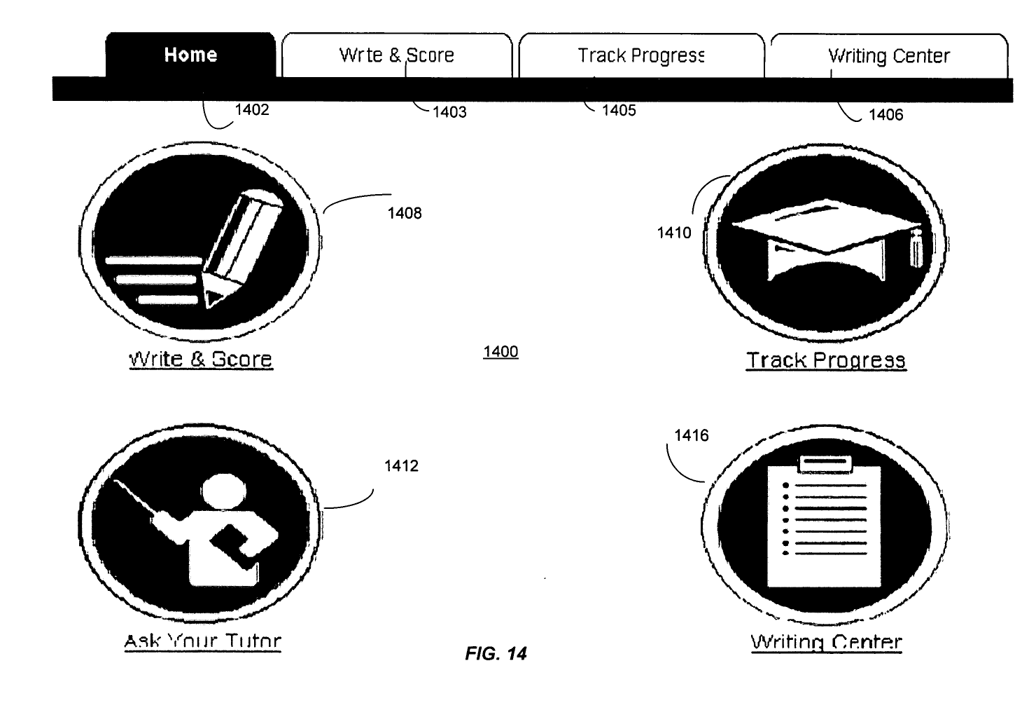

In one embodiment of the invention a student uses student system 150 to interact with text evaluation system 100 by logging onto a text evaluation system website. The text evaluation website is provided by a web interface subsystem 1100 of system 100. The web interface subsystem 1100 provides a GUI enabling the student to interact with system 150. FIG. 14 illustrates an example GUI 1400 enabling a student to interact with system 100. GUI 1400 comprises interactive icons, for example 1408, 1410, 1412, 1416. By selecting an icon using a mouse or trackball or other selection device, a student selects for example 1408 “Write and Score”. Other functions and features are selectable by a student, for example, “Track Progress” 1410, “Ask Your Tutor” 1412 and “Writing Center” 1416.

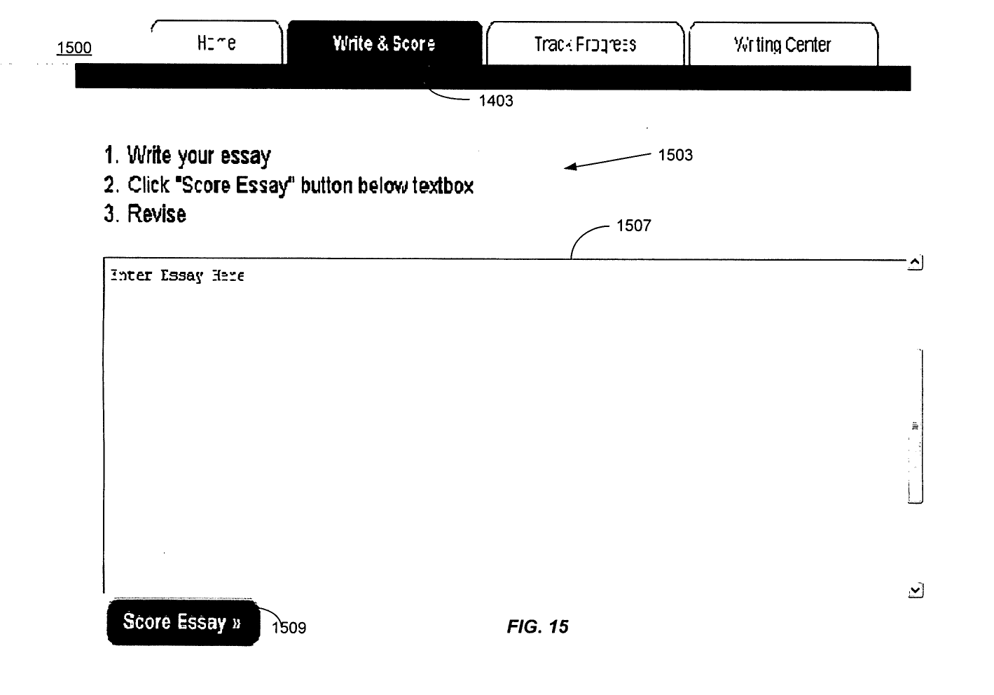

In response to a student selecting write and score” 1408, a user of student system 150 is provided with an interactive screen, for example screen 1500 illustrated in FIG. 15. An example interactive screen 1500 includes an instruction portion 1503, a text entry portion 1507 and a “score” command icon 1509. The student provides an essay to be evaluated by entering essay text into screen portion 1507. One way for a student to provide essay text to be evaluated is by entering the essay text directly to screen portion 1507 using a keyboard. Another way for a student to provide an essay to be evaluated is to upload an electronic document comprising essay text to system 100. Other text entry methods are contemplated including voice to text converters and wireless transmission of text from a remote device such as a Personal Digital Assistant (PDA) or a Blackberry device.

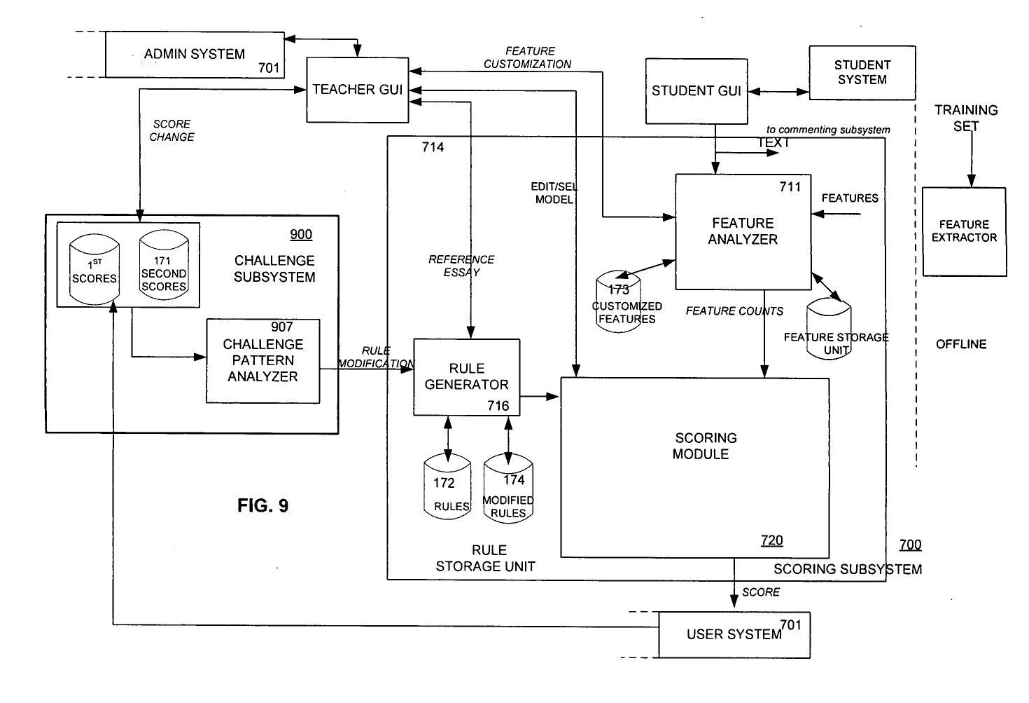

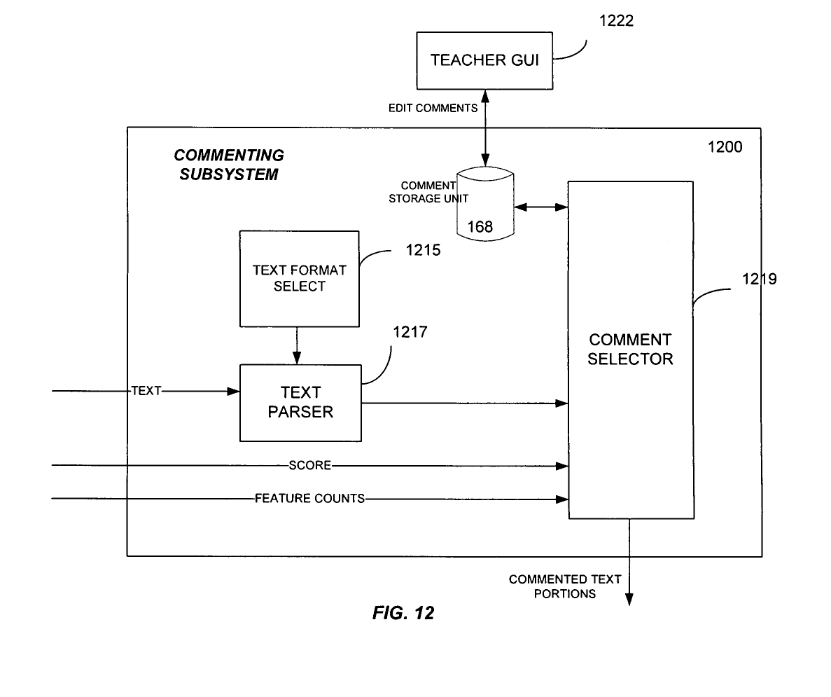

To initiate evaluation of the text appearing in screen portion 1507 a student activates “score” interactive icon 1509. In response to a student activating the score icon 1509, the text is provided to scoring subsystem 700 of text evaluation system 100 (example scoring subsystem illustrated in FIG. 9). According to one embodiment of the invention the text is also provided to commenting subsystem 1200 (example commenting subsystem illustrated in FIG. 12). As those of ordinary skill in the art will appreciate upon reading this specification, a variety of alternative means of initiating text evaluation are possible. For example text evaluation may be initiated in response to other student action such as a student depressing an “enter” key on a keyboard. The user's action triggers transmission of the text and in some cases a signal comprising a request from the user system 150 for text evaluation by system 100.

System 100 evaluates text and returns an evaluation outcome, for example, an essay score. In some embodiments of the invention system 100 provides comments related to the evaluated text. In one embodiment of the invention system 100 provides an evaluation outcome in response to a request within in about 2 seconds from the time of initiation of the request.

In another embodiment of the invention a student downloads, installs and opens stand-alone software implementing text evaluation system 100 on a user system 150. In that case, the student provides an essay and initiates a request for text evaluation as described above. In response to the request student system 150 uses installed system 100 to evaluate the essay text. System 100 evaluates the text and returns the evaluation outcome, in some optional embodiments along with comments, for display on a display device of student system 150. Other embodiments of the invention provide the results in a downloadable file. The file can be stored on user system 150, printed or transmitted to a recipient.

### Intermediate System 107

Returning now to FIG. 1 an intermediate system 107 communicates with text evaluation system 100. In one example embodiment, system 107 implements a web site operated by a third party provider of text evaluation services. Intermediate system 107 is configured to communicate with a second user system 109 to receive text for evaluation from second user system 109. Intermediate system 107 is further configured to provide the text to text evaluation system 100. In one embodiment of the invention intermediate system 107 provides text to system 100 in Extensible Markup Language (XML). In one embodiment of the invention system 100 responds to the request and provides the evaluation outcome and comments, if any, to intermediate system 107 in XML format. However, the invention is not limited to any particular text format. Instead, a variety of text formats are suitable for formatting text to be evaluated and text comprising an evaluation outcome and comments.

### Second User System 109

Second user system 109 is coupled to intermediate system 107 to provide text to be evaluated to intermediate system 107. For example, intermediate system 107 receives a request to evaluate text from second user system 109. In response to the request from second user system 109, intermediate system 107 provides a request to evaluation system 100 to download an Application Program Interface (API) 200 to intermediate system 107. In one embodiment of the invention, intermediate system 109 provides a request, for example a call to system 100 in response to a user of second user system 109 activating an interactive icon of GUI 110. In response to the request from intermediate system 107, system 100 provides API 200 to intermediate system 109.

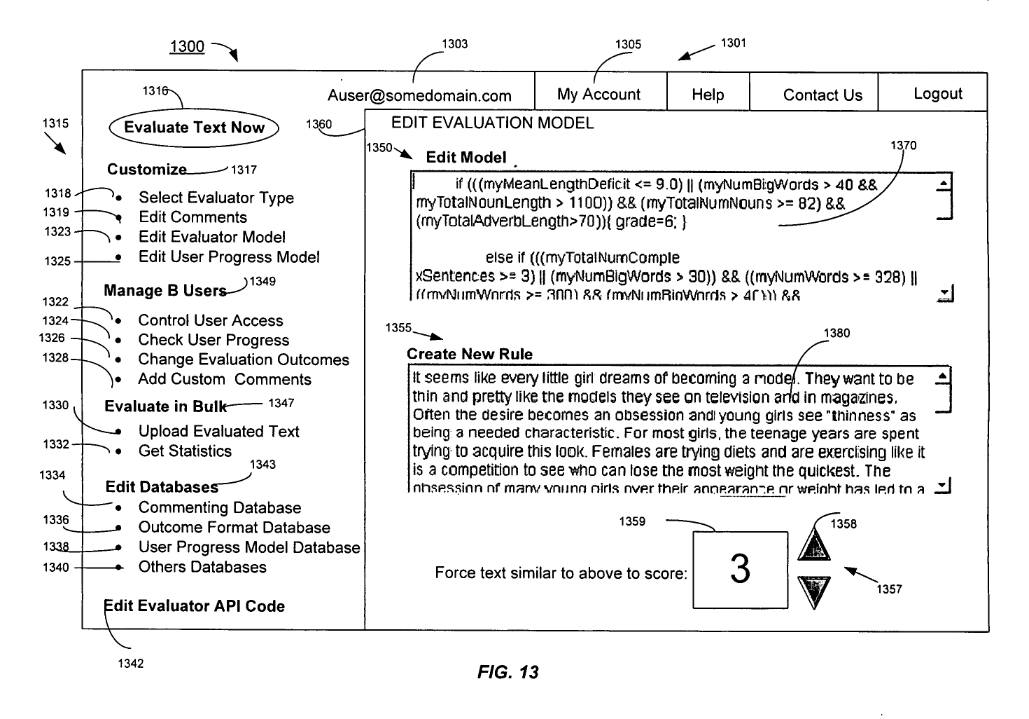

For example, according to some embodiments of the invention text evaluation system 100 is configured to enable a third party provider of text evaluation systems to host text evaluation services related to scoring an essay written by a student writer. In that case, a user is anyone who desires to automatically score a student essay, for example a student, a teacher, a mentor or a coach. The user employs second user system 109 to log into a website hosted by or otherwise provided in association with intermediate system 107. The website of intermediate system 107 provides a second user graphical user interface (GUI) 110 for display on a display device 116 of second user system 109. The user operates second user system 109 to interact with GUI 110 such that text comprising a student essay to be scored is provided to intermediate system 107. FIG. 13 illustrates an example teacher GUI provided by system 100 to second user system 109.

One example of user operation of second user system 109 is a user providing an essay to intermediate system 107. FIG. 15 illustrates an example GUI enabling a student to enter text comprising his or her essay to second user system 109. GUI 1500 includes an instruction area 1503 explaining the operation of the GUI. A text window 1507 is provided to display text entered by the user, for example, via a keyboard coupled to second user system 109. The user operates second user system 109 to cause text comprising the student's essay to be stored in a memory of second user system 109. When evaluation of the essay is desired the user operates selects “score essay” icon 1509. By selecting the score essay icon 1509 a user initiates scoring operation of system 100. In one embodiment of the invention selection of icon 1509 causes the stored essay to be transferred, or uploaded, to intermediate system 107.

In one embodiment of the invention a user of second user system 109 is the student whose essay is to be scored. In other embodiments of the invention a user of system 109 is, for example, a teacher, tutor, mentor, parent, instructor or administrator responsible for scoring student essays. The user's operation of text evaluation system 100 is effected via a GUI 110 provided by intermediate system 107. The GUI is displayed on a display device 116 of second user system 109.

GUI 110 enables a user of second user system 109 to interact with intermediary system 109 to initiate an evaluation, for example a scoring evaluation, of text, for example an essay. For example, in one embodiment of the invention a user activates an interactive icon provided by GUI 110 of system 109 to initiate scoring of the essay. GUI 110 enables a user to communicate with system 100 via an Application Programming Interface (API) 200.

According to an embodiment of the invention API 200 is configured to request, or “call” text evaluation system 100 to provide text evaluation services. API 200 enables second user system 109 to provide text for evaluation to evaluation system 100 via intermediate system 107. Using API 200, intermediate system 107 is enabled to provide text evaluation services to users of second user system 109. An example API specification suitable to implement an embodiment of the invention is provided in Appendix B.

In one embodiment of the invention API comprises an embedded essay scoring system, that is, a scoring system comprising intermediate system 107. In that case a user, for example, a student, teacher, school, test preparation service provider or other user, to customize the look and feel of the embedded essay scorer in accordance with a use suitable for the user's application.

### Text Evaluation System 100

According to one embodiment of the invention text evaluation system 100 comprises a processor 11 configured to control operation of a scoring subsystem 400, a feature storage unit 173 and a rules storage unit 174. When system 100 is implemented via the World Wide Web, a web interface subsystem 1100 is configured to cooperate with processor 11 to provide graphical user interfaces enabling administrators, users of first user system 150 and users of intermediate system 107 to interact with text evaluation system 100.

In one example embodiment of the invention system 100 comprises an essay scoring system. In an example essay scoring embodiment a student operates user subsystem 150 by interacting with a first user system graphical user interface (GUI) 151. GUI 151 is displayed to a user on a display device 114 of 1^{st} user system 150 and configured for communication with system 150.

By interacting with GUI 151 a user causes system 150 to provide text 60, in electronic format, to text evaluation system 100. Text evaluation system 100 receives the text to be evaluated at an input output unit (I/O) 20 of text evaluation system 100. Processor 11 cooperates with I/O unit 20, scoring subsystem 400, rules storage unit 174 and features storage unit 173 to accomplish text evaluation. System 100 provides an evaluation outcome 70 to first user system 150 indicating results of the evaluation. The evaluation outcome is provided to the user of system 150 by displaying the outcome on display device 114. Other means for providing evaluation outcomes to a user include providing the results to printers, faxes, emails and speech devices comprising user system 150.

In addition to scoring subsystem 400 and web interface subsystem 1100 further embodiments of text evaluation system 100 comprise additional subsystems. Additional subsystems include a score challenge subsystem 600, a user progress subsystem 500, a commenting subsystem 1000 and an administrator subsystem 1200.

### Web Interface Subsystem 1100

Web interface subsystem 1100 provides application program interface (API) module 200. An application programming interface (API) is a source code interface used by evaluation system 100 to support requests made by user systems. In one embodiment of the invention web interface subsystem 1100 is configured to cooperate with a graphical user interface (GUI) provided by intermediate system 107.

The graphical user interface, in cooperation with API 200 enables users, e.g., an administrator of intermediate system 107, a teacher or third party to customize features and functions of the text evaluation process carried out by evaluation system 100 on behalf of the user id associated with the teacher or administrator of intermediate system 107. In one embodiment of the invention a user of intermediate system 107 installs API 200 on intermediate system 107. In that embodiment API 200 resides on system 107 indefinitely. To install API 200 a user copies the code from a website provided by text evaluation system 100 and pastes the code to intermediate system 107. An example of API code according to one embodiment of the invention is provided in Appendix C.

In another embodiment of the invention API 200 is provided by text evaluation system 100 to intermediate system 107 in response to each request for an evaluation of text made by intermediate system 107. While resident, API 200 enables remote operation of system features by both end users and system administrators. In another embodiment of the invention system 100 provides API 200 to intermediate system 107 in response to a request signal received from intermediate system 107. After system 100 has provided an evaluation outcome to intermediate system 107, API 200 is removed from intermediate system 107.

In one embodiment of the invention API 200 is implemented as an application program interface (API) comprising JavaScript. Other embodiments of API 200 implement other API standards, e.g., Portable Operating System Interface (POSIX), Single Unix Specification (SUS) and Windows API, to name but a few. In other embodiments of the invention API 200 is implemented as an application binary interface (ABI).

FIG. 13 illustrates a GUI 1300 configured to cooperate with API 200 to provide features and functions enabling teachers, administrators, tutors and others to customize the text evaluation process 1317, manage users such as students 1349, evaluate a plurality of texts 1347 and edit databases stored in storage subsystem 99 (best illustrated in FIG. 1). In the example illustrated in FIG. 13 a display screen portion 1315 comprises at least one user selectable icon for selecting customization and management features of system 100.

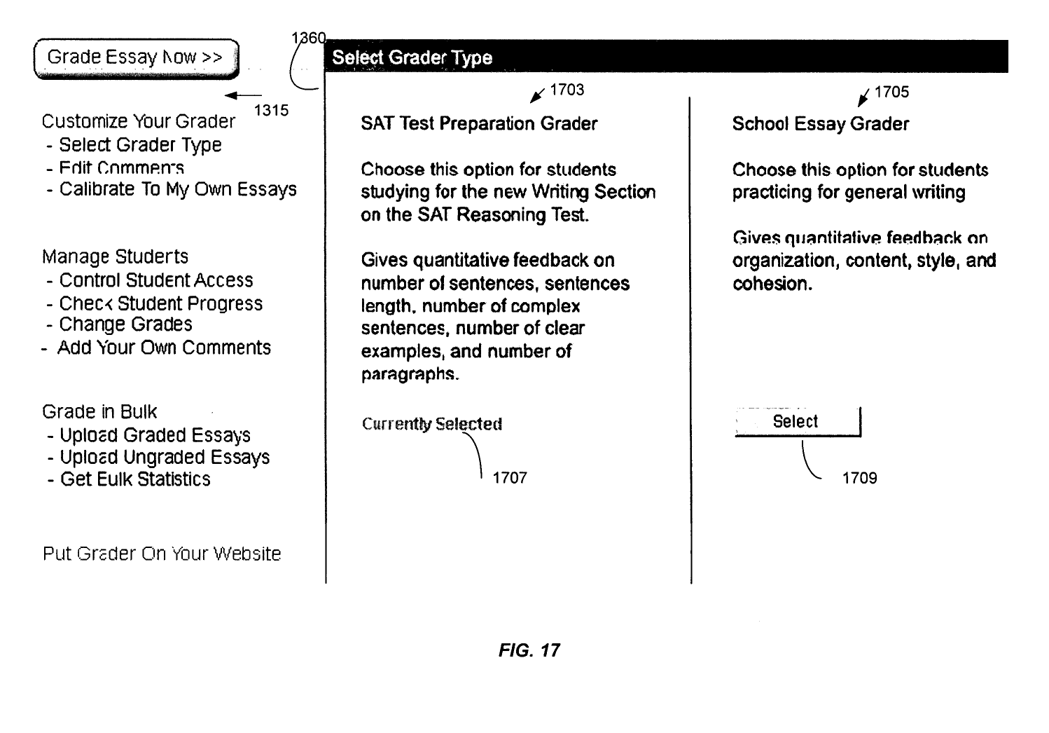

Examples of customization options include selecting an evaluator type 1318. An evaluator type indicates the type of document or test instrument to be evaluated. FIG. 17 illustrates an example GUI 1700 enabling a teacher to select a test type. Examples of test types include, for example, Scholastic Aptitude Test (SAT) 1703 and School Essay 1705.

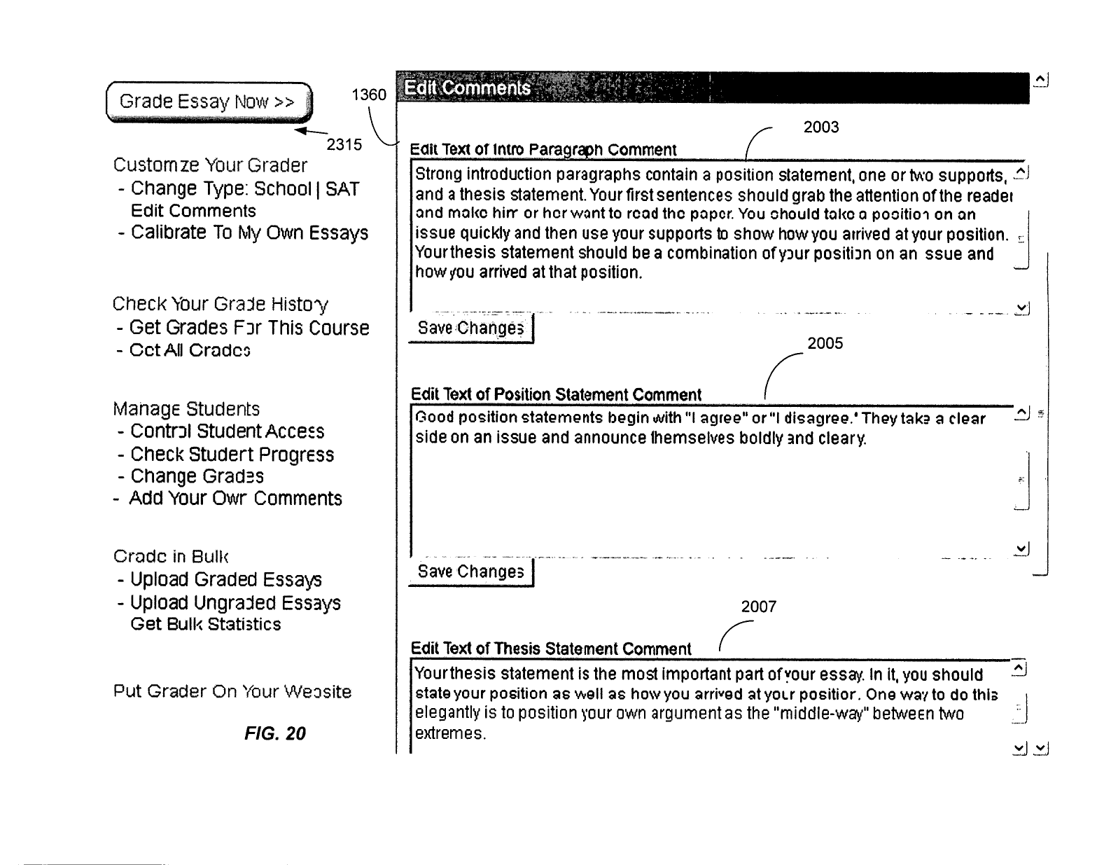

Another selectable option is editing comments 1319. Some embodiments of the invention provide comments in association with text portions in addition to providing a score for a text. FIG. 20 illustrates an example GUI 2000 enabling a user to edit comments. A screen portion 1360 comprises text box portions 2003, 2005 and 2007. Text box portion 2003 enables editing of a comment associated with a paragraph of an essay. Text box portion 2005 enables editing of a comment associated with position statement of an essay. Text box portion 2007 enables editing of a comment associated with a thesis statement of an essay.

Another selectable option is to edit evaluation models 1323. FIG. 13 illustrates a GUI 1300 enabling editing of evaluation models. Text box 1350 enables direct editing of a model. Text box 1355 enables entry of an essay from which a new rule is generated. The new rule is incorporated in a model.

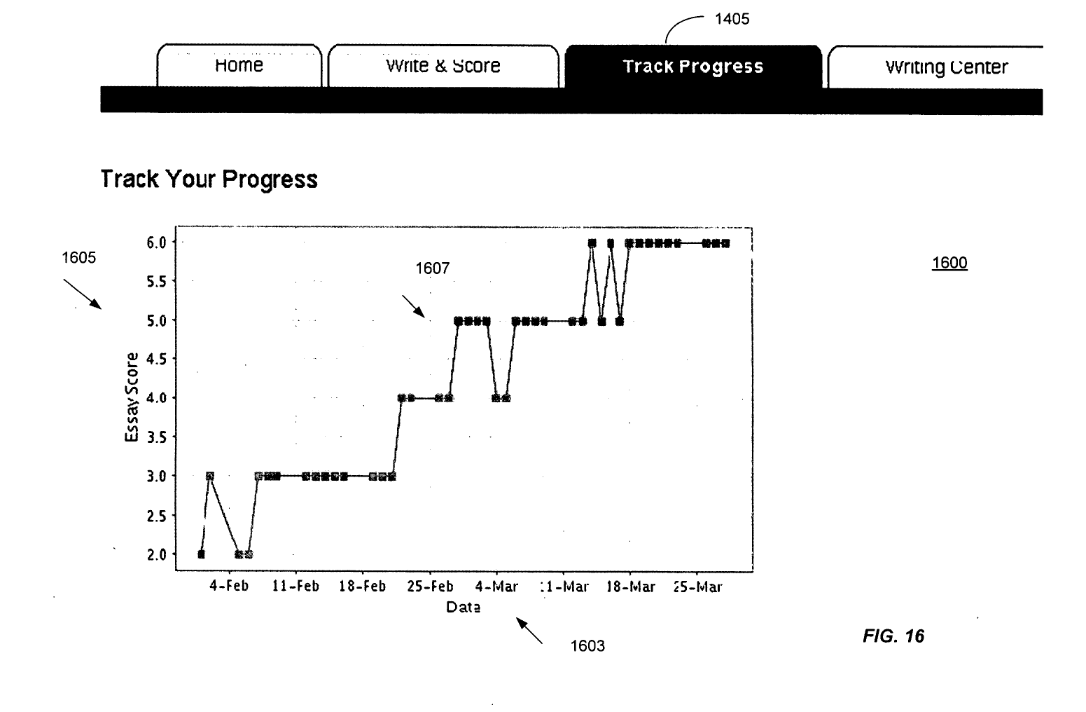

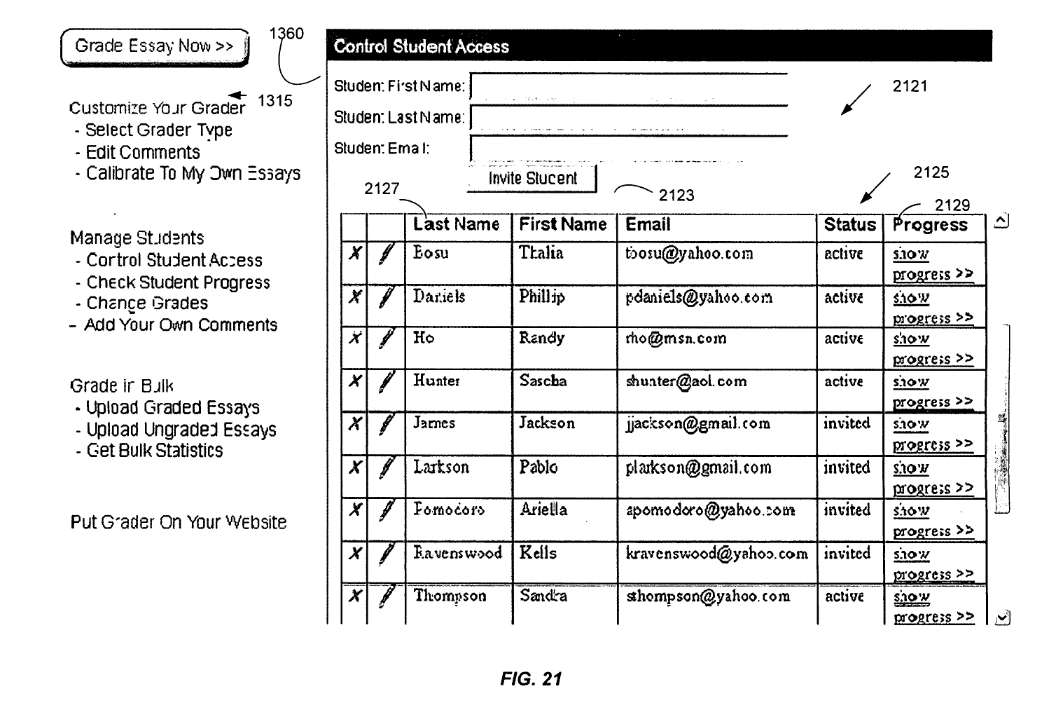

Another customization option is to edit user progress models 1325. An example of a user progress report in accordance with a user progress model is illustrated in FIG. 16 at 1600. Examples of user management options 1349 include controlling user access 1322. An example of a GUI enabling user management is illustrated in FIG. 21. A portion 2101 of a display screen 2100 displays student names comprising an access list. Of course, the number of students comprising a list of student names can vary. The lists illustrated in the drawings comprise a convenient number for illustration purposes. It will be understood the invention is not limited with regard to number of names or items comprising an illustrated list.

A student is added to the access list by entering the student's name in a data entry portion 2105 of display screen 2100. Each student in the list is identified as having an active, inactive or invited status.

Another selectable user management option is to check user progress 1324. Another selectable option is to change evaluation outcomes 1326. This is also referred to herein as “challenging” an outcome or score. Another selectable user management option is adding custom comments at 1328. Examples of evaluation operations related to a plurality of texts (“Evaluate in Bulk” 1347) include uploading evaluated texts 1330. Another selectable example of an operation performed on a plurality of texts is “Get Statistics” 1332. Examples of editing databases 1343 include editing a commenting database 1334, editing an outcome format database 1336, editing databases 1343, editing a user progress model database 1338 and editing other databases at 1340.

In that manner, web interface subsystem 1100 enables users, administrators and other operators of intermediate system 107 to provide text evaluation services to users of second user systems 109. In one embodiment of the invention intermediate system 107 provides a website that enables users in remote locations, e.g., teachers, mentors, coaches, and students, to interact with intermediate system 107 to effect evaluation of text by system 100. In some embodiments of the invention intermediate system 107 evaluates text in response to a request from a user of second user subsystem 109 and provides an evaluation result for display on GUI 110 of display device 116 within about 2 seconds.

In some embodiments of the invention API 200 further includes an interface enabling a user, for example a client such as an educational institution or private tutoring enterprise to adjust GUI 1300 to the user's needs. Therefore API 100 enables a client, for example, to modify the look and feel of the text evaluation GUI to a particular client's business needs. In addition API 200 enables an administrator of intermediate system 107 to access and edit evaluation models, databases, processes and other functions performed by the various modules and subsystems of system 100 as described further herein.

In one embodiment of the invention web interface subsystem 1100 includes a web interface customization tool. Using the customization tool, text evaluation system 100 is customizable in real time. In one embodiment the customization is accomplished from a remote location, for example during a system demonstration.

### Administrator Subsystem 1200

Returning now to FIG. 1 there is illustrated an administrator subsystem 1200 of system 100. As described above, an administrator GUI 111 (detailed example illustrated in detail in FIG. 13 at 1300) enables a system administrator to interact with various modules to adjust, for example, rules and features of scoring subsystem 400 and challenge score reference values of challenge score subsystem 600. Progress reporting features of user progress subsystem 900 are also editable by an administrator. In addition administrator GUI 111 enables an administrator to adjust stored reference features, models, history, user data and rules. In one embodiment of the invention GUI 111 enables an administrator to select between adjusting text evaluating aspects of system 100 with respect to individual users and also with respect to groups of users. In one embodiment of the invention results of customizing are effective when the change is made. Therefore evaluation of the immediately subsequently provided text will take place in accordance with the customized evaluation parameters.

### Storage Subsystem 99

Returning again to FIG. 1, text evaluation system 100 further comprises a storage subsystem 99 according to an embodiment of the invention. Storage subsystem 99 comprises a comment storage unit 168, a user information storage unit 170, a user history storage unit 171, a scoring model storage unit 172, a scoring feature storage unit 173, and a rule storage unit 174. It will be understood by those of ordinary skill in the art, upon reading this specification, that storage units comprising storage subsystem 99 need not be physically separate units. Instead portions of a single memory may be allocated to comprise storage units 168-174.

A processor 11 cooperates with scoring subsystem 400, score challenge subsystem 600, user progress subsystem 900, commenting subsystem 1100, web interface subsystem and administrator subsystem 1200 to store and retrieve data from storage subsystem 99 to carrying out operations of system 100 and its subsystems.

### FIG. 9 Scoring Subsystem Block Diagram

FIG. 9 is a block diagram of a scoring subsystem 700 of a text evaluation system 100 according to an embodiment of the invention. Scoring subsystem 700 comprises feature analyzer 711, rule generator 716 and scoring module 720.

### Feature Analyzer 711

To evaluate a text system 100 examines a text to determine feature counts. Features are a combination of attributes of a type of text that captures important characteristics of the writing. In other words a feature is an individual measurable attribute of the text being observed. A feature extractor 780 selects a subset of relevant features from a set of texts. The selected features are stored in a feature storage unit 172. Examples of features deployed in various embodiments of the invention include, but are not limited to the example characteristics indicated in Table 1 below. It will be understood by those of ordinary skill in the art, upon reading this specification, that a wide variety of text characteristics are suitable to comprise features in various embodiments of the invention. Accordingly the invention is not limited to the particular example features described herein.

TABLE 1

| FEATURE | DESCRIPTION |
|---|---|
| Average Word | Zipf's law indicator of uniqueness, salience |
| Frequency Class | and importance of a word. |
| Total Adverb Length | Total characters of an adverb. |
| Mean Sentence Length | Difference between actual average sentence |
| Deficit | length and target average sentence length. |
| Total Number Big Words | Total number of proper nouns and proper |
| | adjectives |
| Total Noun Length | The total number of characters in nouns in a |
| | text. |
| Number of Complex | Total number of sentences containing at least |
| Sentences | one dependent clause. |
| Number of Misspelled | Total number of words not found in a selected |
| Words | dictionary. |
| Number of Unique | Total number of unique words in a text. |
| Words | |
| Total Number of Words | Total number of words in a text. |
| Total Number of | The total number of sentences in a text. |
| Sentences | |
| One Word Prepositions | Total number of one word prepositions |
| Beginning Sentence | beginning a sentence. |

AverageWordFrequencyClass. The frequency class of a word is directly connected to Zipf's law and is an indicator of a word's uniqueness, salience, and importance. For example, assume C is a corpus of text essays and let f(w) denote the frequency of a word wεC. The word frequency class c(w) of a word wεC is log 2(f(w*)/f(w)), where w* denotes the most frequently used word in the corpus of text essays. In most cases, w* denotes the word “the”, which corresponds to the word frequency class 0. The most uncommonly used words within the corpus might have a word frequency class of 20 or above. An essay's averaged word frequency class reveals the style, complexity, and size of the author's vocabulary.

TotalAdverbLength: The total length, in characters, of the adverbs in a text.

MeanSentenceLengthDeficit: According to a novel scoring model employed by some embodiments of the invention an ideal average sentence length is 19 words for high school writing, 22 words for undergraduate writing and 23 words for graduate writing. Thus 19, 22, and 23 are target sentence lengths. MeanLengthDeficit is the absolute value of the difference between the actual averaged sentence length and the target sentence length for the paper. Other scoring models employ different ideals in other embodiments of the invention.

TotalNumBigWords: The total number of proper nouns and proper adjectives in a paper. BigWords can be individual words like “America” or they can be clustered phrases like “United States of America” in which the entire phrase counts as one BigWord.

TotalNounLength: The total length, in characters, of the nouns in a text.

NumComplexSentences: The total number of sentences containing at least one dependent clause.

NumMisspelledWords: The total number of words not found in a robust spelling dictionary for the essay's target language.

NumUniqueWords: The total number of words in an essay that are unique. In the essay “This is a very very short essay.” There are 7 total words but only 6 unique words.

TotalNumWords: The total number of words in an essay.

TotalNumSentences: The total number of sentences in an essay.

OneWordPrepositionsBeginningSentence: The total number of one word prepositions beginning a sentence in the essay. For example, the sentence “For love, he would do anything.” is a sentence starting with the one word preposition “For”. This is in contrast to multi-word prepositions like “Insofar as”.

According to embodiments of the invention features are adaptable to a user's evaluation outcome history, comment history, progress relative to a course, and progress relative to other users with similar characteristics, for example, students of similar ability. Features of system 100 are customizable in real time from a remote location such as system 107 in accordance with a particular user's desires.

For example, if a default scoring model is inappropriate for a particular population of students, the scoring module is accessible. Operation of the scoring module is adaptable to provide customized scoring on a user-by-user basis. In one embodiment of the invention, a user with administrative access to system 100 is enabled to login to system 100 remotely, that is from second user system 107 to make changes. The results of the changes are effective immediately. Immediately after the change is made, subsequent scored essays may be scored in accordance with changes made remotely.

Feature analyzer 711 receives text to be evaluated from a source of text such as student system 150. Feature analyzer 711 analyzes the text to detect the presence of features in the text in accordance with features store d in a feature storage unit 173. Examples of features are outlined in Table 1 above. Module 711 analyzes the text to determine counts for each feature. Feature module 711 provides the feature counts to scoring module 720.

When text associated with the user id is received, edited features associated with that user id are provided to feature module 711. In that case, feature module 711 provides feature counts based upon the edited features.

Rule Generator 716

In one embodiment of the invention a rule generator provides rules based on at least one known scored essay. An example rule representation is as follows:

If (TotalNounLength>50 & TotalNumWords<100)→Score=1

From the known scored essay, the rule generator extracts a set of features. The rule generator employs a propositional rule learner comprising an off the shelf machine learning algorithm. One example of a commercially available machine learning algorithm is found in the open source machine learning package WEKA. WEKA is a collection of machine learning algorithms for data mining tasks. The algorithms are applied directly to a dataset or called from Java code.

Rules can be arbitrarily long or short and can contain any combination of logical operators, features, and feature values. There can be multiple rules for the same scoring outcome. A human user can quickly edit the rules stored in rule storage unit 174.

A rule module 716 provides rules retrieved from a rule storage unit 174 to scoring module 720. Scoring module 720 applies rules from rule module 716 to feature counts from feature module 711. According to some embodiments of the invention users of text evaluation system 100 are enabled to modify rules stored in rule storage unit 174 and features stored in feature storage unit 173. A user interface module 714 is configured to communicate with a user system 701. User system 701 is operable by, for example, a teacher or system administrator. The user interacts with a GUI to edit features and rules associated with the user's user id. The edited rules are stored in rule storage unit 174. The edited features are stored in feature storage unit 173.

If edited rules are associated with the user id associated with received text, rule module 716 retrieves the edited rules for that user id from rule storage unit 174. Rule module 716 provides the edited rules to scoring module 720. For a given text and user id provided to feature module 711, scoring module 720 applies corresponding edited rules, if any, to the edited features, if any, to determine a n evaluation outcome, e.g., a first score, for the text.

Scoring Module 700

A scoring module scores an essay in accordance with a scoring model comprising a list of rules. In one embodiment each user is provided with an individualized scoring model. Scoring criteria is influenced by a user progress model associated with a student. In one embodiment of the invention scores are provided in accordance with a scoring format. The scoring format can be controlled via a Score Format Database. Examples of score formats suitable for use in embodiments of the invention include, but are not limited to the following:
{1, 2, 3, 4, 5, 6, 7, 8, 9, 10}
{A, B, C, D, F}
{Fail, Poor, Average, Good, Excellent}

FIG. 11 illustrates a scoring module 720 comprising scoring subsystem 700. Scoring module 720 comprises a scoring model selector/updater 781, a scoring model database 785 and a score calculator 783. A teacher GUI 714 enables a teacher to select or change scoring models store in database 785. Rules comprising scoring models 785 are provided by rule generator 716 (illustrated in FIG. 9). A feature count for the text to be scored is provided by feature analyzer 711 (illustrated in FIG. 9). A score calculator 783 compares the rules comprising a selected scoring model provided by scoring model selector/updater 781 to feature counts provided by feature analyzer 711. Score calculator 783 provides the result of the comparison in the form of a score.

### Score Challenge Subsystem 900

FIG. 9 Score Challenge Block Diagram

FIG. 9 is a block diagram of a challenge subsystem 900 configured to communicate with a scoring subsystem 700 to enable a user to “challenge” a score provided by scoring module 720. A user, for example a teacher, interacts with score challenge subsystem 900 via a GUI. FIG. 13 illustrates an example GUI 1300 according to an embodiment of the invention. GUI 1300 provides an interactive menu 1315 that allows a teacher to select an operation to perform using text evaluation system 100. To challenge a score a teacher selects an option for “changing evaluation outcomes” for example as indicated at 1326. Of course, a number of labels are possible to indicate an option for changing a score, or an evaluation outcome. The example indicated at 1326 is merely one example of a label for this function. Other examples are “challenge score”, “challenge outcome”, “challenge”, to name but a few possible labels for an option to initiate an outcome challenge process.

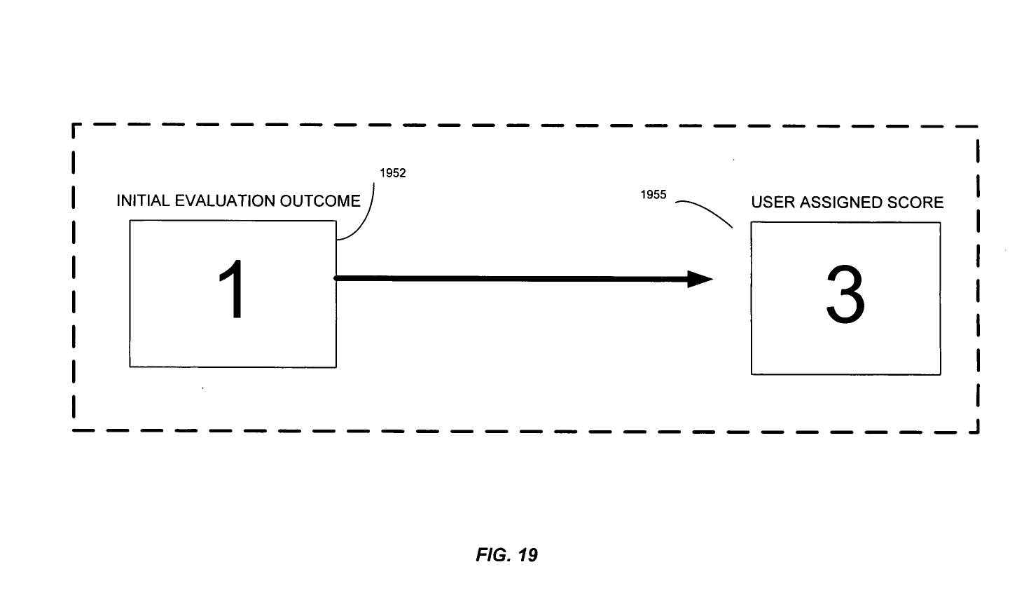

By selecting a challenge option as indicated at 1326 a teacher is provided with interactive screen portions for changing an outcome provided by the scoring system of system 100 to a teacher selected outcome. FIG. 19 illustrates an example interactive screen 1900 according to one embodiment of the invention. In this example a teacher chooses to change system provided score of “1” (indicated at 1953) to a teacher assigned score of 3 (indicated at 1955).

FIG. 9 illustrates an administrator system, for example a teacher system, 701. System 701 displays a GUI similar to that of GUI 1300 which provides an option to change a score. When the “change score” option is selected system 701 communicates with challenge subsystem 900. The teacher identifies a test whose score is to be changed. A score can be changed for an individual student, for a particular test, or for a class of students who took a particular test. For example, the teacher enters a student identifier such as name, id number or other unique student identifier to retrieve the test score information associated with that student from first score database 172. The teacher then selects the score to be changed and effects the change using, for example, GUI 1900 illustrated in FIG. 9. The teacher selected score is stored in a second score database 171. In a similar manner, a teacher is enabled to change a score for a particular test instrument. In that case the score change would apply to all students associated with the test instrument.

Challenge subsystem 900 allows text evaluation system 100 to adapt to tutors/teacher's grading styles overtime. When system 100 provides an evaluation outcome, e.g., a score, to a teacher, the teachers can challenge the score. In one embodiment of the invention a teacher challenges a score by interacting with a GUI providing an interactive “challenge” icon. In addition the GUI provides a field for a teacher to enter an alternative score for the essay. An example of an alternative score is a score the teacher would have assigned to the essay had the teacher manually graded the essay. Text evaluation system 100 receives and stores, the original score, the essay text, and the teacher's challenge score. These are stored in a history storage unit 171.

In one embodiment of the invention rules are updated based upon challenge history. In one embodiment system 100 analyzes challenge history at periodic intervals, for example, once a day. The time interval between challenge history analyses is adjustable. Therefore the invention is not limited to any particular period or frequency for analyzing challenge history. System 100 analyzes challenge history variables such as the number of challenges, the kind of challenges (e.g. a number of score=2s mapping to score=3s) and features associated with the challenges. The outcome of the analysis defines a subset of essays in the set of all essays for which challenges exist. Features associated with the subset of essays are provided to the rule generator. The rule generator updates scoring models based on the features. Subsequent essays relying on the same scoring models will be scored in accordance with the updated scoring models.

If an updated model is provided by the rule generator for an essay associated with a group of students, models for that student group are automatically updated. For example, students whose teacher challenged the score can comprise a group. In that case, models for that group will be updated. In another example embodiment a group comprises all the students of a school or enterprise providing a scoring service based on text evaluation system 100. In that case models for that school or enterprise will be updated.

### User Progress Subsystem 1100

FIG. 11 is a block diagram illustrating a user progress subsystem 1100 configured according to an embodiment of the invention. User progress subsystem 1100 comprises a score history storage unit 171 (also illustrated in FIG. 1 at 171), a progress analyzer 1103, and a user progress model unit 1101. Score history unit 171 stores scores provided by scoring module 720. The scores can be associated with tests, with students, with classes and with teachers. A user progress model provides a reference against which a student's scores are compared. In response to a request for a progress report user progress subsystem provides a report in one of a variety of selectable formats.

FIG. 16 illustrates a user progress report 1600 according to an embodiment of the invention. Report 16 plots essay scores along a first axis 605 and test dates along a second axis 1603. Thus the report provides a graphical illustration 1607 of how a student's scores improve, decline or remain unchanged as the student progresses through a course.

One embodiment of user progress subsystem 1100 accounts for different rates of learning among individual students. Further, embodiments of user progress subsystem 1100 are configurable to account for different motivational and instructional feedback for different individual students. For example, according to one embodiment of the invention user progress subsystem is coupled to scoring model selector 781 of scoring module 720. Scoring model selector 781 automatically selects a scoring model from scoring module storage unit 785 based on user progress information received from user progress analyzer 1103.

In one example embodiment scoring models are selected to be more lax during a first portion of a course relative to a last portion of the course. As the course progresses progressively more strict scoring models are selected. In that manner embodiments of the invention enable scoring criteria to be automatically adjusted over time.

In one embodiment of the invention the strictness of the scoring is accomplished by automatically dropping certain features from consideration for a particular students paper (i.e. for a very poor speller who has learned English as a Second Language, system 100 drops misspelled words in order to boost scores temporarily for student confidence). Additionally, the threshold for a certain feature is adjustable.

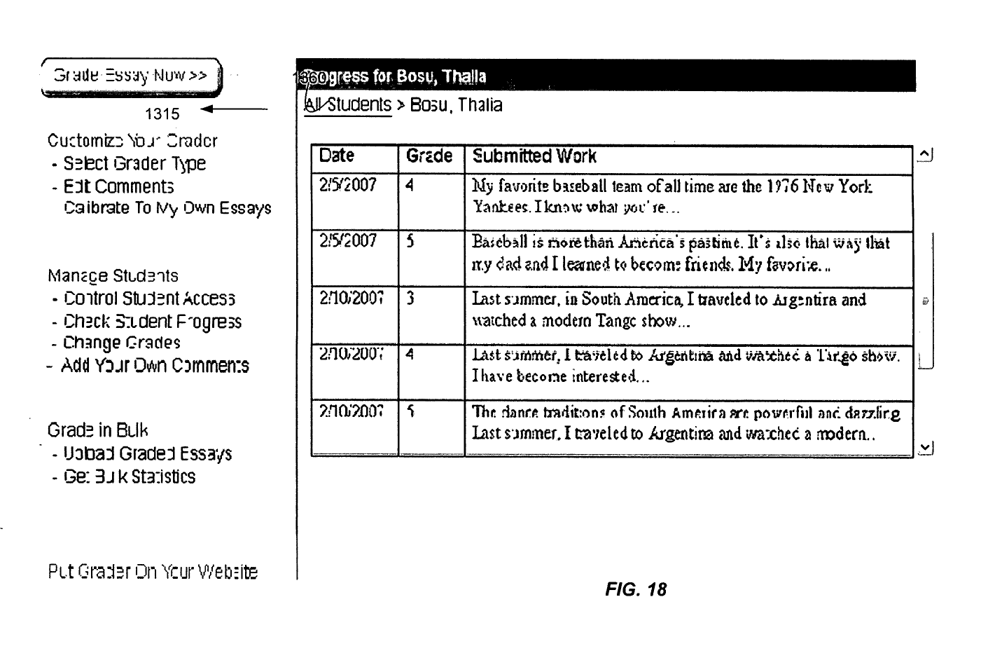

Similarly, commenting is adjustable in accordance with user information provided by user progress subsystem 1100. Commenting subsystem 1000 automatically adjusts comments, for example, comment grammar and structure to become progressively advanced (e.g., to include comments related to parallelism and voice of an essay) based on student progress information provided by user progress subsystem 1100. A teacher GUI 1120 enables a teacher to interact with user progress subsystem to retrieve information about a student's progress. FIG. 18 provides an example display screen 1800. Evaluation dates are provided in one portion 1805 of a progress matrix 1803. A grade for each evaluation is provided in a corresponding portion 1807 of display screen 1800. A portion of text comprising each submitted essay is provided another portion 1809 of display screen 1800.

In one embodiment of the invention, user progress subsystem 1100 provides information to users relating the user's progress to the level of a reference student group. For example, a user's progress is rated average if the user has achieved the same progress level as the average progress level of other students in a reference group. The user is rated above average if the user achieved a level higher than the reference group average.

In one embodiment of the invention user progress subsystem identifies students whose evaluation outcomes indicate a need for assistance such as tutoring or a need for greater academic challenge or mentoring. In one embodiment of the invention, an administrator establishes criteria by which students will be identified for attention. For example, evaluation outcomes lying outside a single standard deviation may be associated with a need either for assistance or for more challenging material. In that case, students whose evaluation outcomes place them outside of one standard deviation from the average score of a reference group are identified to a teacher or supervisor who can adjust the pace, level or delivery method of instruction. Teacher interaction with user progress subsystem is enabled by teacher GUI 1120.

### Commenting Subsystem 1200

A commenting subsystem 1200 comprises a comment selector 1203, a comment storage unit 1268, a text format selector 1270 and a text parser 1273. Text parser 1273 receives text comprising an essay from a student system 750 as illustrated in FIG. 9. Text format selector 1270 provides information about structure and format of the text based on the type of essay to be evaluated. Essay types accommodated by system 100 include SAT, GRE, GMAT and other known essay types as well as custom essay formats. An example essay format may comprise an introductory paragraph, a position statement and a thesis statement.

Commenting subsystem 1200 is configurable to accommodate a variety of sentence types. In one example embodiment a topic sentence states the conclusion that the evidence in the rest of the paragraph will support. A support sentence contains supporting evidence for the statement made in the topic sentence. A position statement takes a clear position on an issue. A thesis statement develops the position statement by summing up how the position was reached. A concluding statement restates the thesis in an alternative manner. A variety of other se

In that case, text parser parses the text in accordance with the selected format. The parsed text is provided to comment selector 1203. Feature counts are also provided to comment selector 1203. In addition a score for the essay may be provided to comment selector 1203.

Comment selector 1203 selects comments from comment storage unit 1268 for each paragraph or sentence of the essay. The comments are selected based on feature counts. The text portions including the selected comments are provided at an output of commenting subsystem 1200. The specific text comprising comments stored in comment storage unit 168 is customizable. For example comments are customizable by a teacher, evaluator or administrator using a GUI such as that illustrated in FIG. 20. FIG. 20 illustrates but a few examples of possible components of an essay. As those of ordinary skill in the art will appreciate upon reading this specification a variety of essay types, components and arrangements of components are possible. System 100 is configurable to accommodate any essay type or component arrangement. Therefore, the invention is not limited with respect to essay types or essay components.

In one embodiment of the invention text evaluation system 100 assigns comments to sentences of a text to be evaluated. Comments are, for example, based on a plurality of paragraph-level features and sentence-level features including sentence and paragraph positioning. Comments directed to the presence of misspelled words, quotations, proper nouns, proper adjectives, and grammar errors are provided in some embodiments of the invention. Embodiments of the invention provide comments based on at least one of: paragraph position, sentence position, length in words of paragraph or sentence, misspelled words in a paragraph or sentence, quotations found in a paragraph or sentence, proper nouns and proper adjectives found in a paragraph or sentence (referred to herein as “BigWords”), an indication that a paragraph or sentence contains a fused sentence, and other grammar errors associated with a paragraph or sentence comprising a text.

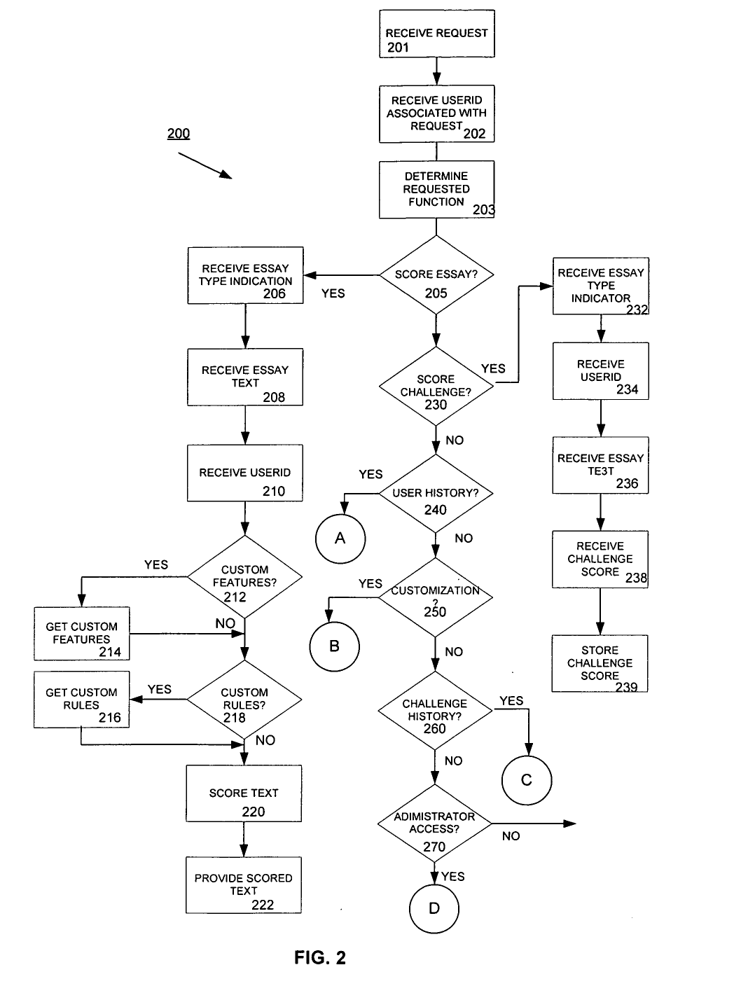

### FIG. 2 Text Evaluation Method

FIG. 2 is a flowchart illustrating steps of a method for automatically evaluating text according to an embodiment of the invention. At step 201 a request to evaluate text is received by a text evaluation system.

At step 203 the text evaluation system determines a task related to the request. If the requested task is to score text (step 205) the next step is to receive an indication of the text type. Examples of text types include texts comprising essay types formatted in accordance with a test types, e.g., SAT, GMAT, etc.

At step 208 the text to be evaluated is received. At step 210 a user id is received. At step 212 the user id is used to determine if custom features are to be employed to evaluate the received text. If custom features are not to be employed to evaluate the text, the method continues to step 218. If custom features are to be employed the custom features are retrieved in step 212 and the method resumes at step 218.

At step 218 the user id is used to determine if custom rules are to be employed to evaluate the received text. If no custom rules are to be employed the method continues to step 220. If custom rules are to be employed as per step 218 the custom rules are retrieved at step 216 and the method resumes at step 220. At step 220 the text is scored. At step 222 the evaluated test is provided, for example to a system user who has requested the text evaluation.

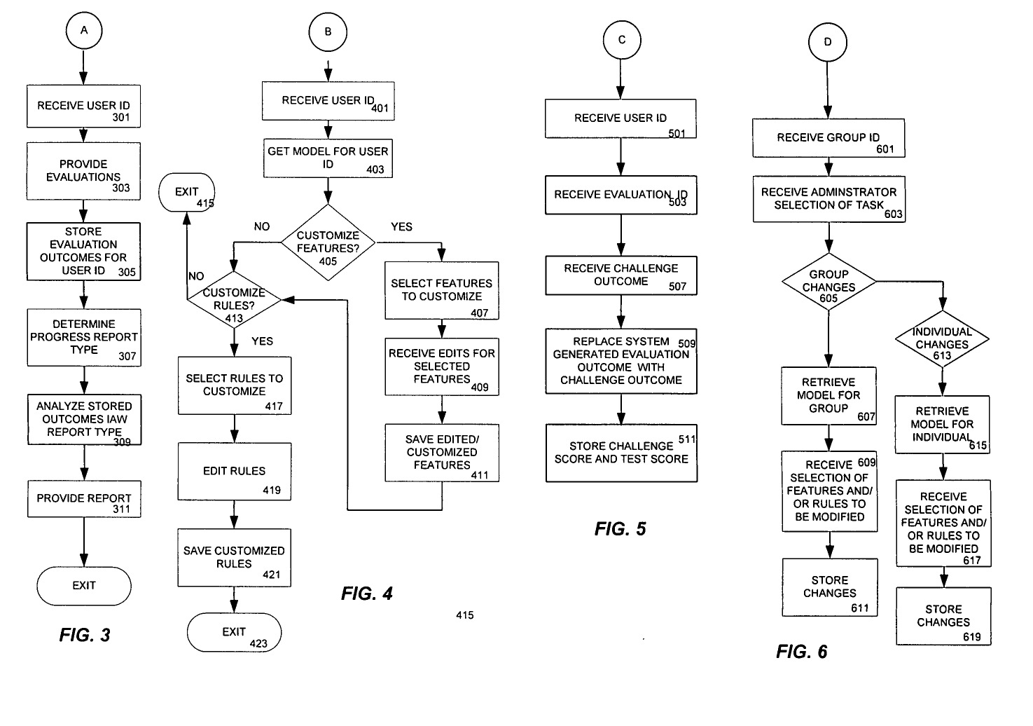

### FIG. 3 Steps for Analyzing User Progress

FIG. 3 is a flowchart illustrating steps for carrying out an embodiment of the method depicted in the flowchart of FIG. 2 wherein a user progress report is provided. At step 301 a user id is received. At step 303 an indication of the type of report requested is received. At step 305 data related to the history of the user associated with the user id received in step 301 is retrieved from a user history storage unit (best illustrated in FIG. 1 at 171). At step 307 the data is formatted in accordance with the selected report type. At step 309 a report comprising the formatted data is provided. In one embodiment the report is provided by displaying the report on a display screen such that the user can view the report. In another embodiment of the invention a report is provided by enabling the user to print the report. Other suitable means for providing a report include email, regular mail and audio reporting.

### FIG. 4 Steps for Customizing

FIG. 4 illustrates steps enabling a user to customize evaluation criteria according to an embodiment of the invention. At step 401 a user id is received. At step 403 an evaluation model associated with the user id is retrieved. If a user request is to customize features of the model, as determined in step 405, the user's selection of features to customize is received at step 407. At step 409 edits, for example, feature edits made by a user, are received. At step 411 the edited features are saved. In one embodiment of the invention the evaluation model associated with the user's id is updated in accordance with the edited features and the revised model is saved at step 411.

At step 417 a determination is made if the user requested to edit user rules. If the request is to edit user rules, user selection of rules to be edited is received at step 417. At step 419 changes to the selected user rules are effected. At step 421 the modified rules are stored. In one embodiment of the invention the modified rules are stored by updating an evaluation model associated with the user id received in step 401. In that case the updated model is stored at step 421. At step 423, and also at step 415, the method exists after the desired modifications to selected features and rules have been effected.

FIG. 5 Steps for Challenging Evaluation Outcome

FIG. 5 illustrates steps of a method enabling a user to challenge a system generated evaluation outcome. At step 501 a user id is received. At step 503 an indication of the specific evaluation to be challenged is received. At step 507 a challenge outcome is received. A challenge outcome is an outcome determined by means other than automatic evaluation system 100. For example, a teacher is enabled to score a student's test in accordance with the teacher's own scoring criteria. If the score assigned by the teacher is different than the score provided by automatic evaluation system 100, the teacher can change the system generated score. The teacher can substitute his or her own score for the system generated score. At step 511 the challenge score is stored as the actual score for the specified evaluation. In some embodiments of the invention both the challenge score and the system generated score are stored in a history unit (for example, history unit 171 of FIG. 1).

### FIG. 6 Steps for Enabling Administrator Customization

FIG. 6 illustrates steps of a method enabling a system administrator to customize evaluation criteria. At step 601 a user id is received. In some embodiments of the invention the user id received in step 601 comprises a group id, i.e., an administrator id. An administrator id is associated with a group of individuals. Each individual may also be associated with an individual id. Therefore, the administrator is enabled to change evaluation parameters in at least one of a variety of ways. For example, an administrator can change evaluation parameters on an individual basis, that is, for an individual user. In addition an administrator can change evaluation parameters for groups of individuals such that changes to the evaluation parameters are applied to all individuals comprising the group.

At step 603 the administrator associated with the group id received in step 601 selects an action. In one embodiment of the invention a graphical user interface is provided to the administrator. The GUI comprises a menu of options. The options are selectable by the administrator. In that case step 601 is carried out by receiving an indication of an administrator selected option.

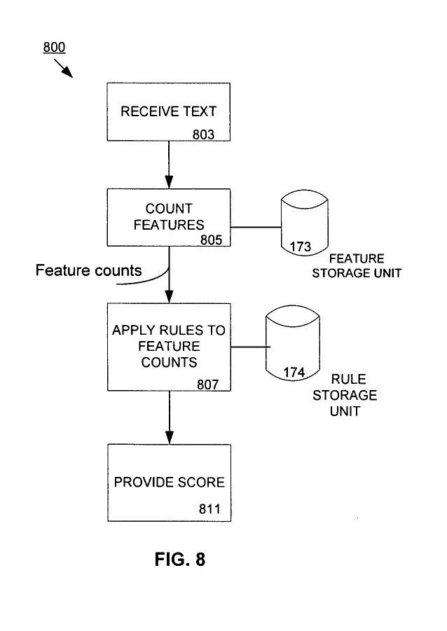

### FIG. 8 Text Evaluation Method

FIG. 8 is a flowchart of a scoring method according to an embodiment of the invention. At step 803, text to be evaluated is received. At step 805 the text is evaluated in accordance with features stored in a feature storage unit 173. Thus a feature count is provided for each feature comprising text provided by a user. Features to be counted for a text are selected from feature storage unit 873 based on a user id associated with the text. At step 807 rules are applied to the feature counts. At step 811 an evaluation outcome is provided.

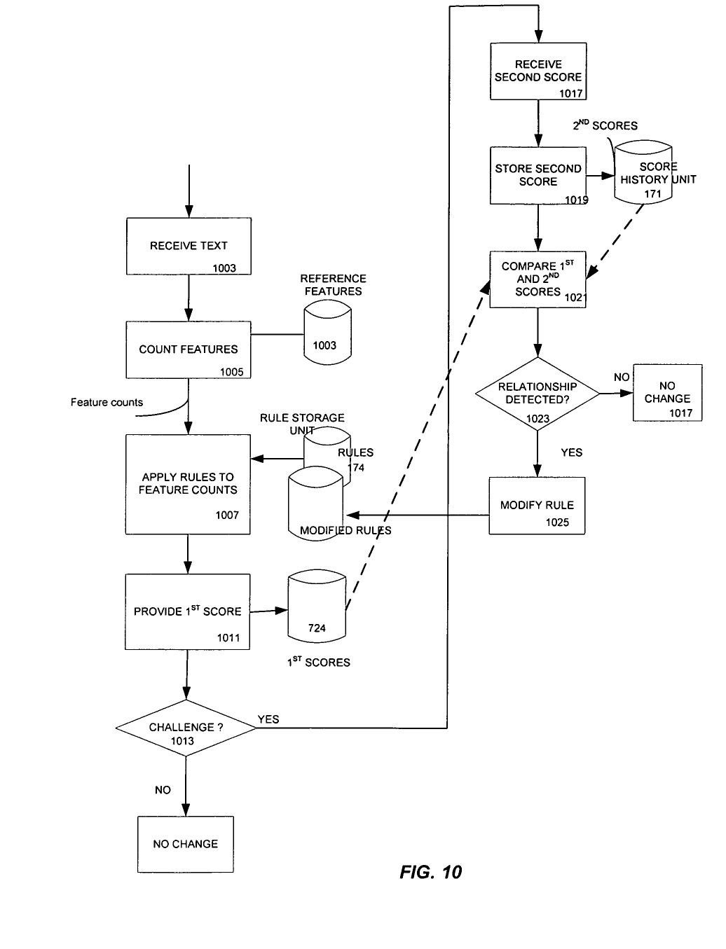

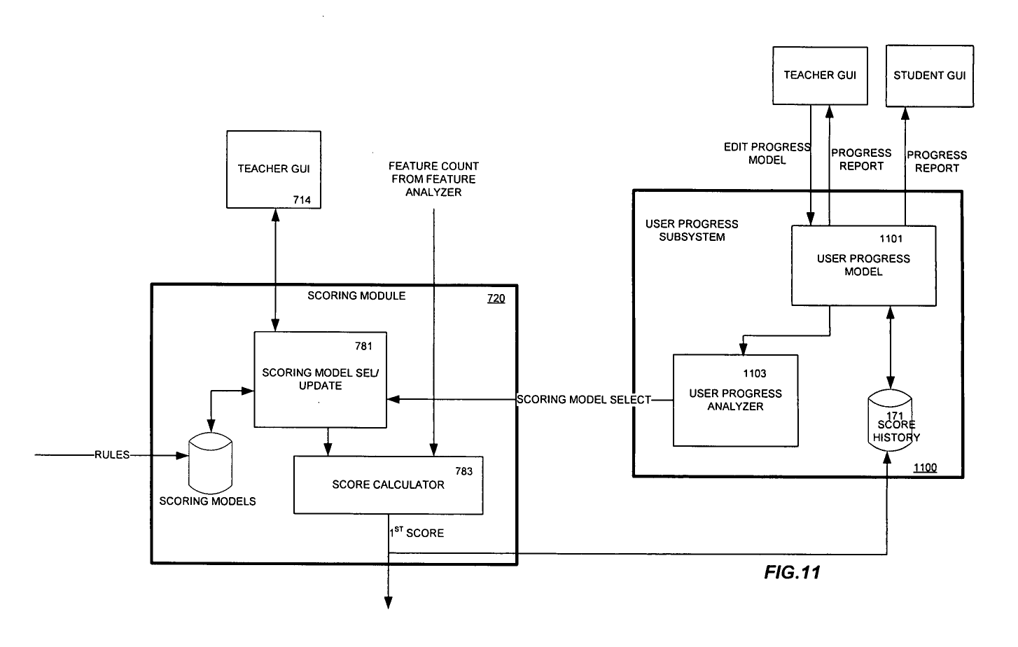

### FIG. 10 Scoring Method Including Score Challenge Feature

FIG. 10 is a flowchart illustrating steps of a scoring and challenge method according to an embodiment of the invention. At step 1003 text is received. At step 1005 features comprising the received text are counted. Features to be counted are determined based on features stored in feature memory unit 1003. At step 1007 rules are applied to the feature counts provided by step 1005. At step 1011 a first score for the text is provided. The first score is based upon the outcome of the rule applying step. The first score is stored in a score storage unit 724. Step 1013 determines if a challenge is received relating to a first score. If a challenge is received step 1017 receives the challenge score, i.e., a second score. At step 1019 the second score is stored.

At step 1021 a plurality of first and second scores are compared to determine if a score challenge pattern exists at step 1023. If a score pattern challenge is determined at step 1023 a rule is modified to adjust the scoring in accordance with the challenge pattern.

While the invention has been shown and described with respect to particular embodiments, it is not thus limited. Numerous modifications, changes and enhancements will now be apparent to the reader.

What is claimed is:

1. A system for evaluating text, the system including an input for receiving text to be evaluated and an output for providing an evaluation outcome, the system comprising:
a feature module coupled to said input to receive said text, said feature module providing a feature count for at least one feature of said text;
a rule module comprising at least one text evaluation rule;
an evaluation module coupled to said feature module and to said rule module, said evaluation module applying said evaluation rule to said feature count to provide said evaluation outcome.

2. The system of claim 1 wherein said rule module includes:
a set of reference rules;
a user module configured to enable a user to modify said set of reference rules;
said evaluation module configured to provide an evaluation outcome for said text based upon said at least one feature count and said modified set of reference rules.

3. The system of claim 1 wherein said feature module comprises:
a memory comprising a plurality of stored features;
a user module configured to enable a user to modify said stored features;
a processor coupled to said feature module and configured to provide said at least one feature count for said text in accordance with said user modified features.

4. The system of claim 1 wherein said rule module includes:
an input for receiving a challenge to said evaluation outcome;
a challenge pattern analyzer coupled to said input and configured to determine a relationship between said evaluation outcome and said challenge to said evaluation outcome and to provide an indication of said relationship;
a processor coupled to said challenge pattern analyzer and to said rule module and configured to automatically modify stored reference rules based upon said indication of said relationship.

5. The system of claim 4 wherein said rule module includes:
at least one stored model comprising a set of reference rules;
a processor coupled to said stored model and to said rule module and configured to modify said set of reference rules in accordance with said indication of said relationship.

6. The system of claim 1 wherein said evaluation module comprises:
a plurality of evaluation models, each evaluation model corresponding to a unique user,
a processor coupled to said evaluation module and configured to automatically modify said evaluation models in accordance with evaluation outcomes corresponding to said unique users.

7. The system of claim 1 further comprising a comment module including:
a comment store comprising stored comments;
a text parser;
a processor coupled to said comment store, said text parser and to said feature module, said processor configured to automatically associate at least one of said stored comments to at least a portion of said text based at least in part on said feature count.

8. A method for automatically evaluating a text comprising an electronic document comprising steps of:
defining at least one feature;
defining at least one rule for evaluating said text based on said at least one feature;
counting instances of said at least one feature in said text to arrive at a feature count for said text;
applying said at least one rule to said feature count;
providing an evaluation outcome based upon said the outcome of said rule application.

9. The method of claim 8 further wherein the step of providing an evaluation outcome is carried out by a steps of:
storing comments related to at least one of said feature counts and said rules;
selecting comments to comprise said evaluation outcome based upon said feature count for said text and said outcome of said rule evaluation.

10. The method of claim 8 including steps of:
storing said features in a memory;
enabling a user to modify said stored features;
providing at least one feature count for said text in accordance with the user-modified features.

11. The method of claim 8 including steps of:
receiving a challenge to said evaluation outcome;
analyzing said evaluation outcome and said challenge to determine a relationship between said evaluation outcome and said challenge to said evaluation outcome;
providing an indication of said relationship;
automatically modifying stored reference rules based upon said indication of said relationship.

12. The method of claim 11 further including steps of:
storing at least one model comprising a set of reference rules;
modifying said set of reference rules in accordance with said indication of said relationship.

13. The method of claim 1 including steps of:
storing a plurality of text evaluation comments;
parsing said text;
automatically associating at least one of said text evaluation comments with at least a portion of said parsed text based at least in part on said feature count.

14. The method of claim 1 including steps of:
providing a text evaluation application interface module to a 3^{rd} party system;
receiving requests related to text evaluation from said 3^{rd} party via said text evaluation application interface module;
performing text evaluation functions in response to said request.
